(19) United States
(12) Patent Application Publication
(10) Pub. No.: US 2026/0252487 A1
(43) Pub. Date: Aug. 27, 2026

(54) METHOD AND DEVICE FOR MANAGING HOST AREA

(71) Applicant: Korea Advanced Institute of Science and Technology, Daejeon (KR)

(72) Inventors: Youjip WON, Daejeon (KR); Juwon KIM, Daejeon (KR)

(73) Assignee: Korea Advanced Institute of Science and Technology, Daejeon (KR)

(21) Appl. No.: 19/538,418

(22) Filed: Feb. 12, 2026

(30) Foreign Application Priority Data
Feb. 21, 2025 (KR) 10-2025-0023172
Nov. 18, 2025 (KR) 10-2025-0174419

(51) Int. Cl. G06F 12/02

(52) U.S. Cl. CPC G06F 12/0276

(57) ABSTRACT

Disclosed is a method and device for managing a host area. A storage device for eliminating garbage collection overhead of a host having a log-structured filesystem and a garbage collection method thereof are configured to set a portion of a filesystem partition as a garbage collection region used by the storage device, and to allocate a new logical block address to valid pages in the garbage collection region, while migrating the valid pages of a victim block to a destination block.

### CROSS-REFERENCE TO RELATED APPLICATION(S)

This application claims the priority benefit of Korean Patent Application Nos. 10-2025-0023172, filed on Feb. 21, 2025, and 10-2025-0174419, filed on Nov. 18, 2025 in the Korean Intellectual Property Office, the disclosure of which is incorporated herein by reference.

### BACKGROUND

### 1. Field of the Invention

The present disclosure relates to a method and device for managing a host area.

### 2. Description of the Related Art

In various storage media, for example, flash, shingled magnetic recording (SMR), and dynamic random access memory (DRMA), consecutively placing data is much faster than placing each of the data apart. In line with this characteristic, numerous studies have proposed storing data in a log-structured manner. These methods include a log-structured filesystem and a log-structured merge-tree (LSM-tree) based key-value store.

However, despite its promising characteristics, the log-structured filesystem has critical drawback, overhead of reclaiming invalid filesystem blocks, that is, garbage collection overhead. Garbage collection needs to suspend an incoming write request and to perform update and checkpointing on a filesystem state, which leads to significant performance degradation and excessive tail latency.

Numerous studies were proposed to mitigate the garbage collection overhead. Examples of the studies include a method of performing garbage collection in a pre-emptible manner, a method of performing garbage collection during an idle period, a method of clustering filesystem blocks with similar lifespans in the same section, a method of offloading consolidation of valid filesystem blocks to a storage device, and a method of exporting an excessively large filesystem partition to prevent section shortage.

However, these approaches each have its own strength and weakness, there is still significant room for improvement. For example, fully pre-emptible garbage collection is practically impossible to implement, and predicting the idle state of filesystem is very difficult. Also, an approach of exporting a very large filesystem partition requires a flash translation layer (FTL) to manage an excessively large logical block address (LBA) space, which leads to excessive memory pressure and complexity in the logical-to-physical (L2P) mapping design.

A modern flash storage device performs device-level garbage collection to reclaim an invalid flash page. Therefore, when a log-structured filesystem runs on top of the flash storage device, both the filesystem and the storage device perform their own garbage collection routines in an independent manner. This causes redundant write amplification and degradation in the system performance. To reduce this redundant garbage collection overhead, some studies have proposed performing garbage collection solely at the host level. In this case, since a host directly reclaims invalid flash blocks, device-level garbage collection is eliminated. However, this approach still suffers from costly filesystem-level garbage collection overhead, for example, checkpoint overhead, or user request suspension.

As a result of comparing the overhead between the filesystem-level garbage collection and the device-level garbage collection, both cases lead to the degradation in application program performance, however, it is found that the filesystem-level garbage collection has a much larger impact. That is, the filesystem-level garbage collection lowers benchmark throughput by about ⅕, while the device-level garbage collection reduces the performance by up to 20%.

### SUMMARY

The present disclosure proposes a novel approach of eliminating garbage collection overhead in a log-structured filesystem. The essential idea is that a storage device reclaims a free section on behalf of a filesystem with minimum interference to the foreground filesystem activity. That is, the present disclosure exploits the garbage collection mechanism of an underlying storage device to reclaim free sections in the log-structured filesystem. This approach is distinguished from the existing studies in that rather than the filesystem delegating garbage collection to the storage device, the storage device performs the garbage collection on behalf of the filesystem.

To implement this, there are three technical challenges to be addressed. First is a filemap update issue. A storage device needs to update a logical block address (LBA) of a consolidated (valid) flash page and to synchronize the same with a host. Second is a lightweight device-host interface. The storage device needs to efficiently transmit LBA update information to the host, and does not need to cause excessive input/output (I/O) communication overhead. Third is timely performing device-level garbage collection. Before the filesystem runs out of free sections, the storage device needs to perform device-level garbage collection in a timely manner to provide the sufficient free space.

These challenges are addressed through the following three key technical techniques, coupled garbage collection (CGC), migration upcall, and virtual overprovisioning (VOP). In coupled garbage collection, the device-level garbage collection not only consolidates valid flash pages but also remaps the pages to a new filesystem location. Through this, coupled garbage collection may consolidate valid filesystem blocks without physically copying them. In migration upcall, the storage device piggybacks a logical block address (LBA) update event to the existing I/O completion signal and transmits the same to the host. Through this, migration upcall may notify LBA update without a need to define separate polling or interrupt. In virtual overprovisioning, the filesystem partition size is separated from the actual physical capacity of the storage device, and the filesystem partition is virtually expanded. Through this, the storage device may timely perform garbage collection to prevent the filesystem from running out of free sections.

Combining these three, the present disclosure proposes a log-structured filesystem with device-driven garbage collection (D2FS). This is a variant of flash-friendly filesystem (F2FS).

The present disclosure provides a garbage collection method of a storage device for eliminating garbage collection overhead of a host having a log-structured filesystem, and the garbage collection method of the storage device may include setting a portion of a filesystem partition as a garbage collection region used by the storage device; and allocating a new logical block address to valid pages in the garbage collection region, while migrating the valid pages of a victim block to a destination block.

The present disclosure provides a storage device for eliminating garbage collection overhead of a host having a log-structured filesystem, and the storage device may include a memory; and a processor configured to connect to the memory, and to execute at least one instruction stored in the memory, and the processor may be configured to set a portion of a filesystem partition as a garbage collection region used by the storage device, and to allocate a new logical block address to valid pages in the garbage collection region, while migrating the valid pages of a victim block to a destination block.

The present disclosure provides a non-transitory computer-readable recording medium storing a computer program to execute a garbage collection method of a storage device for eliminating garbage collection overhead of a host having a log-structured filesystem, and the garbage collection method may include setting a portion of a filesystem partition as a garbage collection region used by the storage device; and allocating a new logical block address to valid pages in the garbage collection region, while migrating the valid pages of a victim block to a destination block.

The contributions of the present disclosure are as follows. First, a host central processing unit (CPU) directly eliminates the overhead of performing garbage collection. It is achieved by combining the existing I/O stack features, for example, device-level garbage collection, filesystem overprovisioning, and NVMe interface. Second, by employing a moderate degree of virtual overprovisioning (e.g., 2.4), it is discovered that free sections may be seamlessly supplied to the filesystem only with the device-level garbage collection. That is, excessive partition expansion is not required even without filesystem-level garbage collection. Third, it is proved that the storage device may deliver file mapping information to the host without relying on host-centric event detection (e.g., polling and interrupt) by piggybacking an update notification to the other I/O completion signal.

In this way, D2FS in which the filesystem-level garbage collection is eliminated outperforms F2FS by 3×, F2FS ported on zoned namespace (ZNS) SSD by 1.7×, log-structured filesystem for infinite partition (IPLFS) by 1.5× (based on YCSB-F). Also, D2FS reduces a device memory pressure by 1/14 compared to IPLFS.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates the concept of filesystem-level garbage collection, device-level garbage collection, and coupled garbage collection;

FIG. 2 illustrates valid flash page consolidation of coupled garbage collection;

FIG. 3 illustrates the concept of I/O command and migration upcall;

FIG. 4 illustrates a migration upcall handling process;

FIG. 5 illustrates virtual overprovisioning;

FIG. 6 illustrates updating a file block on a garbage collection region;

FIG. 7 illustrates a filesystem layout;

FIG. 8 is a block diagram illustrating components of a storage device according to various example embodiments; and

FIG. 9 is a flowchart illustrating an operating method of a storage device according to various example embodiments.

### DETAILED DESCRIPTION

Hereinafter, example embodiments will be described in detail with reference to the accompanying drawings. However, when it is determined to unnecessarily obscure the gist of the present disclosure, detailed description related to a known function or component will be omitted.

The present disclosure provides the mechanism that a log-structured filesystem eliminates garbage collection performed by itself. The present disclosure reclaims invalid sections within a filesystem partition by utilizing a garbage collection function of an underlying flash storage device. The present disclosure calls this a log-structured filesystem with device-driven garbage collection, that is, D2FS.

D2FS includes three key components, that is, coupled garbage collection (CGC), migration upcall, and virtual overprovisioning (VOP). Coupled garbage collection consolidates valid flash pages at the storage device level and remaps migrated flash pages to a new filesystem location such that the valid pages are clustered not only physically but also logically. Migration upcall asynchronously notifies the host about file mapping information updated by coupled garbage collection, minimizing interference with the foreground filesystem operations. Virtual overprovisioning separates the size of a filesystem partition from the physical capacity of an associated storage partition and sets the size of the filesystem partition larger than that of a physical storage partition. Through this, a flash translation layer (FTL) timely performs device-level garbage collection and ensures that the filesystem partition does not run out of free sections. By integrating these techniques, the present disclosure frees the log-structured filesystem from garbage collection overhead, which is a primary obstacle hindering its widespread adoption in production environments. D2FS outperforms F2FS by 3× in the FIO benchmark, zoned F2FS by 1.7× in the FIO benchmark, and log-structured filesystem for infinite partition (IPLFS) by 1.5× in MySQL YCSB-F environment.

### 1. Background

### (1) Flash Storage Device

The flash storage device has three operations, that is, read, write (program) and erase, and defines three corresponding units, that is, page, block, and superblock. A flash page is a write unit, typically ranging from 4 KB to 64 KB. A flash block is an erase unit, including 512 to 1024 pages depending on the SSD design. A modern SSD controller employs multi-level parallelism at channel, way, and chip levels. Here, a superpage and a superblock are units that group a plurality of flash pages and a plurality of flash blocks in parallel at the same offset, respectively. The SSD controller performs write based on a superpage unit and performs garbage collection based on a superblock unit to exploit the internal parallelism.

A flash translation layer (FTL) is present within SSD. The FTL is responsible for logical-to-physical address (L2P) mapping, garbage collection, and wear-leveling. When there runs out of free flash blocks, the FTL performs device-level garbage collection. That is, the FTL selects a victim block, copies valid pages in the victim block to an empty block, and then erases the victim block to reclaim the space. Recent SSDs often perform garbage collection at superblock granularity. Also, flash defines a discard command (or TRIM command). This command informs the storage device about a specific filesystem block that is no longer in use. Through this, the FTL may be prevented from unnecessarily migrating invalid file blocks during device-level garbage collection.

### (2) Log-Structured Filesystem

The log-structured filesystem is an append-only filesystem initially developed to mitigate the seek overhead in accessing data and associated metadata in HDD. The entire filesystem is partitioned into a sequence of fixed-size units, called segments. A segment is a set of filesystem blocks that are allocated and written together to the storage device. When the log-structured filesystem runs out of free segments, the filesystem consolidates valid file blocks to new segments, and reclaims the old segments, which is called garbage collection. Early log-structured filesystems used the segment as a unit for both write and garbage collection. A recent flash-based log-structured filesystem, F2FS, separates the garbage collection unit from the allocation unit (or unit of flush). F2FS defines the garbage collection unit as a section. A section includes one or more segments.

This separation of sections and segments is a very important design decision. To minimize write amplification in reclaiming the free filesystem space, the filesystem needs to align its garbage collection unit size with the device-level garbage collection unit size. However, since the segment size (2 MB) of F2FS is deeply embedded in its design, changing the segment size is practically infeasible. On the other hand, the device-level garbage collection unit differs for each SSD. Therefore, F2FS allows the section size to be independently set, and is designed to be adjustable for the device unit.

The filesystem-level garbage collection requires very high cost. During garbage collection, the filesystem acquires an exclusive lock and suspends all operations (e.g., write( ), unlink( ), create( ), etc.) that change the filesystem state. Also, before and after the garbage collection, checkpointing for the state of the filesystem needs to be performed to ensure the crash consistency of the garbage collection.

### (3) Method of Addressing Garbage Collection Overhead

The existing study handled the garbage collection overhead issue largely into two directions, that is, algorithmic improvement and framework redesign.

### \textcircled{1} Algorithmic Improvement

The most common approach is to cluster file blocks with similar lifespans in the same section. The lifespan of the file block may be estimated based on a file extension, a user hint, or an update frequency. Also, a method of performing garbage collection during an idle period is proposed. There are numerous studies to mitigate the device-level garbage collection overhead. For example, there are a method of exploiting SSD's internal parallelism, a method of coordinating a flash array to hide the garbage collection overhead, and a method of making the garbage collection pre-emptible.

### \textcircled{2} Framework Redesign

From framework perspective, proposed is a method in which a host filesystem directly consolidates valid flash pages of a storage device, eliminating the device-level garbage collection overhead. However, to this end, the storage device needs to expose its internal geometry to the host, which most commercial SSD manufacturers are reluctant to do. Another approach is to use an append-only block device, that is, a zoned namespace (ZNS) SSD. The ZNS SSD organizes its partition using a plurality of zones. Each zone is an array of consecutive flash pages. Each zone may be written only in an append-only manner. A zone is invalidated and reclaimed as a single unit. This method eliminates device-level garbage collection, but passes the burden to an application, which leads to complicating the application design. IPLFS takes the opposite approach. IPLFS removes garbage collection from a filesystem and completely offloads the same to the storage device. IPLFS defines a very large (e.g., ZByte) filesystem partition such that the filesystem does not run out of free sections during the SSD lifespan. However, due to this, the underlying flash storage device needs to handle prohibitively large LBA space in its L2P mapping.

### (4) Device-Managed Filesystem Partition

In modern operating system design, a host filesystem is solely responsible for managing a filesystem partition. However, recently, some studies proposed to endow the storage device with the limited capability to manage the filesystem partition. For example, in Range Write, the filesystem transfers a set of LBAs along with the write command to the storage device. The disk selects a single LBA from among the set of LBAs, writes data, and then returns the result to the host. In Nameless Write, the host transmits a write command to the storage device without specifying a destination LBA. The storage device selects a location to store data, and returns an LBA of the selected location to the host.

An NVMe specification standardizes the concept of this device-managed filesystem partition. For example, zone_append command of ZNS interface specifies only zone ID when writing data. The storage device determines actual offset within the corresponding zone and then informs the host of the location. This function is utilized to optimize the performance of a key-value storage, a redundant array of independent disks (RAID) system, and a swap subsystem.

The present disclosure shares the same philosophy, that is, allowing the storage device to manage the filesystem partition to some extent. However, difference lies in that the present disclosure allows the storage device to directly allocate free blocks within the filesystem partition and to update a filemap.

### 2. Design Principle

The present disclosure exploits the garbage collection mechanism of a flash storage device to reclaim free sections within a filesystem partition. The approach of the present disclosure includes three key technical components, that is, device-driven filemap management, a device-centric I/O interface, and timely garbage collection.

### (1) Device-Driven Filemap Management

For the storage device to consolidate valid filesystem blocks, the device firmware needs to modify an LBA of a physical block and to update a filemap corresponding thereto at the host. Therefore, the storage device needs to seamlessly update a filemap of a filesystem without interfering with ongoing filesystem activity.

### (2) Device-Centric I/O Interface

The storage device needs to inform the host about the updated filesystem state with minimum interference. The existing I/O interface is designed to be host-centric. Both interrupt and polling are designed to capture an event predefined by the host. However, this method is not suitable for informing the host about the device-initiated activity (e.g., device-level garbage collection). The present disclosure argues that there is a need for a new device-centric interface capable of efficiently informing the device-initiated activity.

### (3) Timely Garbage Collection

The storage device needs to timely execute garbage collection to seamlessly provide free sections to the filesystem without any interruption. That is, an execution timing of device-level garbage collection needs to be aligned with the availability of the free sections in the filesystem.

To achieve these three objectives, three specific techniques are developed herein, that is, coupled garbage collection (CGC) that is the mechanism for the device-driven filemap management, migration upcall that is a technique for realizing the device-centric I/O interface, and virtual overprovisioning (VOP) that is a technique for appropriately synchronizing timing of garbage collection. Through these three techniques, D2FS implements the complete device-driven mechanism that maintains the consistency with activity at the host while the storage device performs garbage collection on behalf of the filesystem.

### 3. Coupled Garbage Collection

### (1) Concept

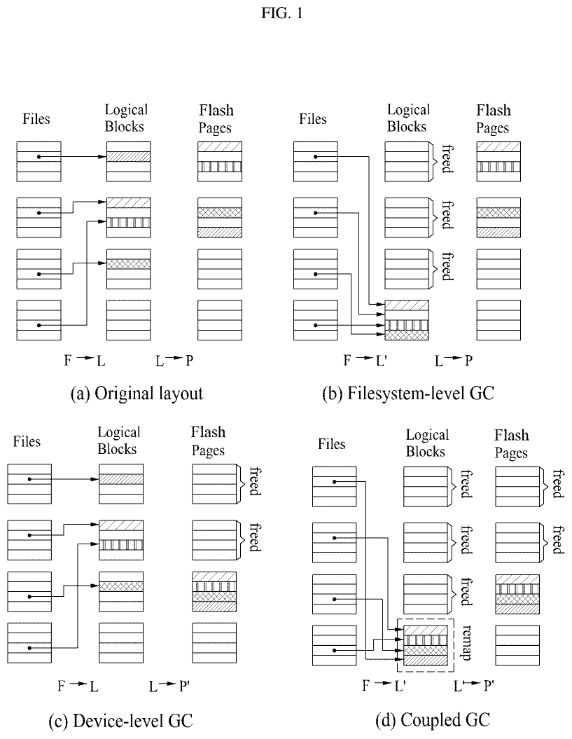

FIG. 1 illustrates the concept of filesystem-level garbage collection, device-level garbage collection, and coupled garbage collection.

Coupled garbage collection (CGC) relates to device-level garbage collection that reclaims not only free blocks at a flash storage device but also free sections at a filesystem. A process of determining an actual physical location of a filesystem block includes two mapping layers: (i) mapping from a file block ([fd, offset]) to an LBA, and (ii) mapping from an LBA to a physical page address (PPA) in the flash storage device. Here, (i) is referred to as file-to-logical (F2L) mapping and (ii) is referred to as logical-to-physical (L2P) mapping. The filesystem navigates through one or more indirect blocks to find an LBA of a file block ([fd, offset]). This structure is called a filemap.

$$[ fd , offset ] {\to }^{F 2 L} LBA {\to }^{L 2 P} PPA \qquad [ Equation 1 ]$$

In the existing I/O stack, F2L mapping is exclusively managed by a host filesystem, and L2P mapping is exclusively managed by an FTL of the storage device. In an original layout ((a) of FIG. 1), there are four sections in a filesystem partition and four flash blocks in a storage device partition. When filesystem-level garbage collection is performed ((b) of FIG. 1), three sections are reclaimed and valid data of a victim block is copied to a new section. During this process, only F2L mapping is updated and L2P mapping remains unchanged. On the other hand, in device-level garbage collection (c) of FIG. 1, the storage device moves valid flash pages to a new block, and updates L2P mapping. In this process, two flash blocks are reclaimed, and the F2L mapping remains unchanged.

Coupled garbage collection ((d) of FIG. 1) simultaneously updates both F2L mapping and L2P mapping by combining the above two stages. That is, after coupled garbage collection migrates pages of a victim block to a new block, the storage device remaps not only a mapping table of the corresponding page but also an LBA of the corresponding page. This process is called remap. As a result, after performing coupled garbage collection, valid flash pages are clustered adjacently, both physically and logically, that is, in the same flash block (physical clustering) and also in the same section (logical clustering). Through this, free sections of the filesystem may be claimed without data transmission between the host and the storage device.

Coupled garbage collection includes the following three key elements, that is, block associative mapping, consolidation of valid blocks, and F2L mapping synchronization.

### (2) Block Associative Mapping

The present disclosure developed block associative mapping. For L2P mapping, a block mapping method is employed. However, unlike the existing block mapping, the FTL of the present disclosure allows valid flash pages within a victim block to be freely placed at any location of a destination block. That is, a block offset of a page may change. This mechanism is called block associative migration, and this mapping scheme is called block associative mapping. This concept is not entirely new. Similar ideas have been used in managing a CPU cache, for example, a set-associated cache, or managing a virtual memory.

To preserve the invariant of block mapping, the present disclosure developed a remap mechanism. That is, when a page migrates to a new block, the FTL updates an LBA of the corresponding page to a new value. For example, if a page with LBA L and physical address P is migrated to a new block, the page will have new LBA L′ and new physical address P′. For example, it is assumed that there are two filesystem sections, starting at LBA 100 and LBA 200, respectively. The former is called block α and the latter is called block β. If LBA 108 page of block α is migrated to block β, changing its offset from 8 to 1, the LBA of the corresponding page is updated from 108 to 201. The existing studies have proposed a method that allows a filesystem to directly manage L2P mapping of the storage device. However, block associative mapping proposes the opposite way. That is, the storage device manages F2L mapping of the host.

### (3) Consolidating Valid Flash Pages

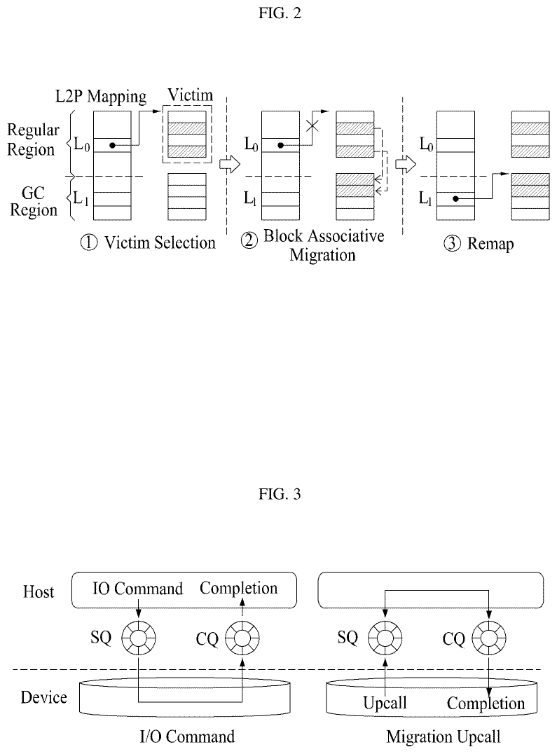

FIG. 2 illustrates consolidating valid flash pages of coupled garbage collection.

A process of consolidating valid flash pages includes three phases, that is, (i) victim block selection, (ii) valid page copy, and (iii) remapping.

In the first phase, an FTL selects a victim block using one of the existing garbage collection algorithms, for example, a greedy method, an age policy, a cost-benefit policy, and a time window method. Currently, coupled garbage collection basically uses the greedy method.

The second phase is block associative migration. The FTL newly allocates a destination block and sequentially migrates valid pages within the victim block to the destination block. Here, the offset of the page may change.

The third phase is remapping. Coupled garbage collection allocates a new mapping table entry and maps the destination block to the new mapping table entry. However, in this process, the storage device may conflict with the host's filesystem. Therefore, the present disclosure reserves a small region in a filesystem partition exclusively for garbage collection region (CG region). This region may be used only by coupled garbage collection. Coupled garbage collection may allocate the mapping table entry only to LBAs belonging to this region. FIG. 2 illustrates an example. Coupled garbage collection migrates valid pages of victim block L₀ to the destination block. The offset of the page changes when the page is migrated to the destination block. When the valid pages are migrated to a new location, the destination block is assigned a mapping table entry L₁ from the garbage collection region. The victim block L₀ is discarded.

As a result, coupled garbage collection integrates filesystem-level garbage collection and device-level garbage collection into one by migrating valid pages of the victim block to a new location and by updating LBAs.

### (4) Synchronizing LBAs to Host

When the storage device updates the LBA of the migrated page, the storage device creates a migration record in the form of <old LBA, new LBA>. This record represents the old LBA and the new LBA of the corresponding page. The storage device stores this record in a buffer and batches the same to the host at regular intervals. When the host receives the migration record, the host updates F2L mapping of filesystem. The migration record has three states, that is, buffered that is a state in which the migration record is created and remains in the buffer, in-flight that is a state in which the migration record is transmitted to the host, but not yet synchronized, and synced that is a state in which the storage device has confirmed that the host reflected the corresponding information in the filesystem. The filesystem updates a filemap based on the migration record. When update is completed, the filesystem notifies it to the storage device. Only then, the storage device may reutilize the relevant mapping table entry.

Until the filesystem state between the host and the storage device is completely matched, that is, until the migration record is in a synced state, a read or discard command may reference an old LBA. To prevent this, the present disclosure developed read-redirect and discard-redirect functions. That is, when the mapping entry table of a specific data block is indicated as NULL, the FTL looks up the migration record and redirects an access to a new location. For example, when the host desires to read LBA 0x000101 and there is a migration record <0x000101, 0x800101> in which the corresponding page is migrated to 0x800101, the FTL automatically redirects the request to a new address.

### 4. Migration Upcall

### (1) Concept

FIG. 3 illustrates the concept of I/O command and migration upcall.

The present disclosure developed an upcall-like mechanism to deliver a migration record created by the storage device to the host. This is called migration upcall. The existing I/O interface mechanisms (interrupt and polling) are designed to be host-centric. Therefore, these schemes are inefficient in informing the host about the device-initiated activity, for example, coupled garbage collection. Using polling may waste host CPU cycles and may affect the foreground application performance. Also, adding separate interrupt for informing the migration activity is not easy. Adding new interrupt involves defining an interrupt number, modifying an interrupt vector table, and writing a new interrupt handler. In addition, in many cases, there is no available interrupt number. Migration upcall is a device-centric I/O interface mechanism designed to solve this issue (FIG. 3). Migration upcall may be implemented by applying the minimal change to the existing I/O stack. There is no need to define any new data structures, interrupt handlers, or interfaces.

Migration upcall includes the following three elements, that is, an upcall ID, an array of migration records, and the number of migration records. The control flow of the migration upcall is opposite to the control flow of the existing I/O command. In the existing I/O, the host submits a command and the storage device processes the command. In contrast, in migration up, the storage device submits an upcall to the host and the host processes it. Then, the host informs the storage device when upcall handling is completed.

The present disclosure defines migration upcall based upon the existing NVMe standard. Migration upcall uses the command data structure of NVMe, and uses NVMe queue pair (submission queue (SQ) and completion queue (CQ)) to transmit and receive a migration record between the host and the storage device. This is called a migration queue pair. The storage device inserts the upcall into migration SQ and notifies the host that the upcall is ready. When the host completes processing the upcall, the host records a completion signal in the CQ and rings a doorbell.

### (2) Upcall Piggybacking

The storage device needs to transmit a notification signal to the host when the storage device inserts the upcall into the migration SQ. However, the present disclosure does not use interrupt nor polling and, instead, developed new mechanism for the same, upcall piggybacking. In upcall piggybacking, the storage device piggybacks an upcall notification signal on the existing NVMe command completion signal.

That is, the storage device adds a newly defined UPCALL flag to the existing completion signal to be transmitted to the host. When an NVMe device driver of the host detects the UPCALL flag, the NVMe device driver wakes up an upcall handler to process the upcall. In this manner, upcall delivery may be efficiently performed without a need to define new interrupt or to perform polling.

Experimental results show that the piggybacking method does not cause any significant delay in delivering migration records. This is because device-level garbage collection is triggered mostly when there are frequent write requests from the host. That is, since there are already enough NVMe completion signals, there is no need to wait for a separate signal for upcall piggybacking. In current implementation of D2FS, a single migration upcall may carry up to 256 migration records.

### (3) Handling Migration Upcall

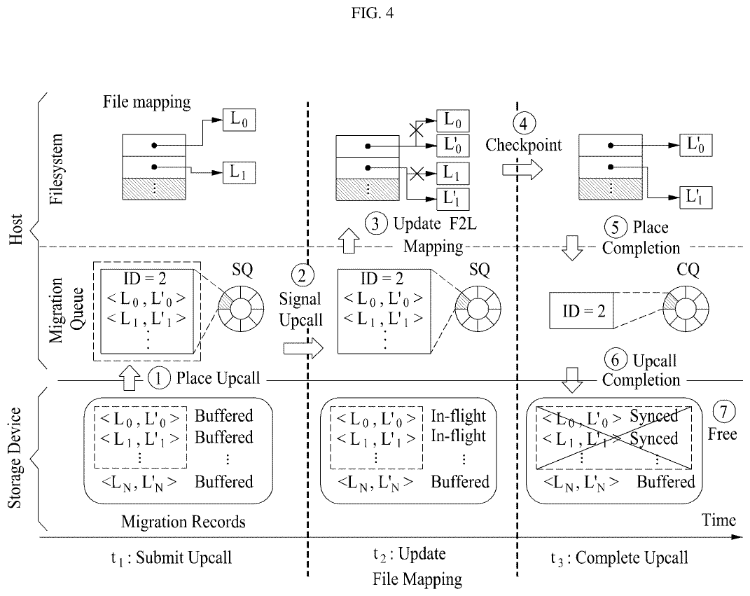

FIG. 4 illustrates a migration upcall handling process. The storage device inserts upcall into SQ of a migration queue (\textcircled{1}). Then, through upcall piggybacking, the storage device informs the host that upcall is ready (\textcircled{2}).

The migration upcall handling process includes the following three phases, that is, update a filesystem state with respect to migration records (update filesystem state), storing the updated filesystem state as checkpoint (checkpoint), and notify the storage device about the completed upcall (notify device). To this end, D2FS allocates a dedicated thread that is responsible for upcall handling. Unless noted otherwise, the following description is based on F2FS-based D2FS implementation.

### (i) Filesystem State Update

An upcall handler reads upcall from the migration SQ and extracts migration records from the upcall. For each migration record, the upcall handler updates file mapping, block bitmap, and reverse mapping (\textcircled{3} in FIG. 4). The block bitmap (segment information table in F2FS) is a data structure to track the allocation status of blocks in each segment. Reverse mapping (segment summary area in F2FS) is a data structure that stores owner information (e.g., inode ID and file offset) of a filesystem block. The upcall handler finds an old LBA of each migration record and updates the same to a new LBA. Then, the upcall handler updates block bitmaps and reverse mapping of the two LBAs. If the old LBA is already invalidated (e.g., unlink( ) call), the upcall handler simply marks it as “serviced” without changing the filesystem state.

### (ii) Filesystem Checkpoint

D2FS performs checkpoint under the same condition as F2FS. That is, D2FS executes the checkpoint when the number of dirty metadata entries or the number of invalid sections exceeds a threshold (\textcircled{4} in FIG. 4). However, this process may be preemptive even in the middle of migration upcall. However, D2FS ensures failure atomicity in a checkpoint process. To this end, two mechanisms are applied. First, D2FS processes migration records in the order in which they are created, and stores (record ID, upcall ID) of a migration record that is most recently processed in a checkpoint pack. Second, D2FS performs atomic processing on a single migration record unit. The upcall handler disables the checkpoint routine when processing a migration record. To this end, the upcall handler acquires a shared lock on a global rwsemaphore to block the checkpoint, and yet allows other threads to access the filesystem.

(iii) Notify Upcall Completion

D2FS considers that the corresponding migration upcall is completed if all of its migration records are reflected to the filesystem and the corresponding state is stored. When the checkpoint completes, a completion thread inserts a completion signal including the corresponding upcall IDs into the migration CQ and rings a doorbell to notify the storage device of this (\textcircled{5} and \textcircled{6} in FIG. 4). The storage device changes the migration record state of the corresponding upcall from in-flight to synced, and asynchronously deallocates the synced migration records ((in FIG. 4).

### (iv) Preserving the Order

The filesystem needs to process migration records in order in which they are created. Coupled garbage collection may migrate the same page multiple times, and the associated migration records may be transmitted as a single batch. Therefore, the upcall handler needs to process internal records of the upcall sequentially in order in which they are created, and the storage device inserts the migration upcall and record in first in, first out (FIFO) order. This ensures the consistency of the filesystem state between the host and the storage device.

### 5. Virtual Overprovisioning

### (1) Concept

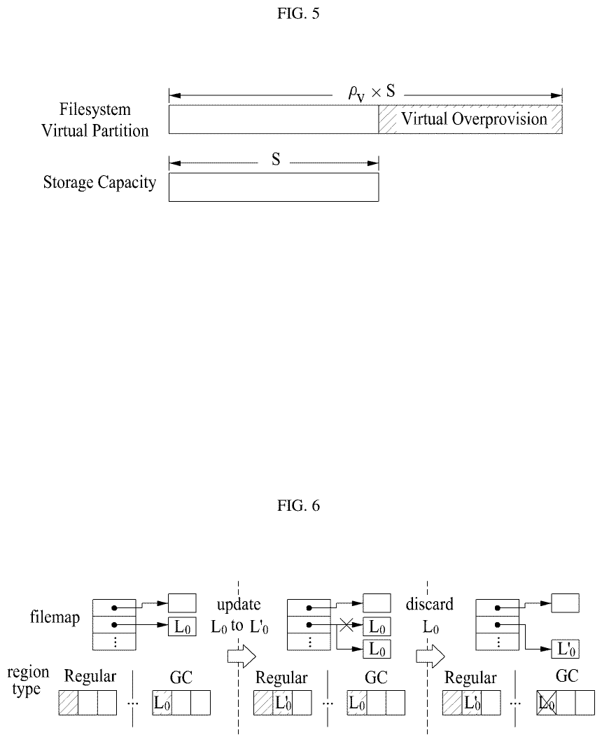

Coupled garbage collection needs to timely reclaim free flash blocks such that the filesystem may be supplied with free sections without any interruption. The approach of the present disclosure is simple and yet effective. The present disclosure separates the size of the filesystem partition from the basic storage device capacity. The filesystem partition size is made to be sufficiently larger than the basic storage device capacity, such that the storage device runs out of free blocks before the filesystem runs out of free sections. This ensures that the coupled garbage collection may be executed to reclaim free sections for the filesystem before the filesystem runs out of free sections. The present disclosure calls this technique virtual overprovisioning. The term “virtual” is used since the overprovisioned space is not physically present. The ratio of the filesystem partition size to the storage device capacity is referred to as the virtual overprovisioning degree, that is, ρᵥ. For example, for 2 TByte virtual partition on 1 TByte storage device, ρᵥ is 2. FIG. 5 illustrates virtual overprovisioning. As the filesystem partition size increases, the filesystem runs out of free sections less frequently. IPLFS is an extreme form of virtual overprovisioning. IPLFS's filesystem partition size is fixed to 8 ZByte. For 1 TByte storage device, ρᵥ is of 2³³ in IPLFS.

Unlike the existing filesystems, D2FS uses the best-effort policy in issuing a discard command to the storage device. When using virtual overprovisioning, it is important for the filesystem to inform the storage device about invalid filesystem blocks as early as possible. In virtual overprovisioning, the filesystem utilization is represented by the number of valid blocks in its partition. As a result, the storage device may run out of free flash blocks while the filesystem is not full. The present disclosure calls this a free section fault. The free section fault occurs when the filesystem does not inform invalid filesystem blocks on time and when there is no invalid flash page for the storage device to reclaim. If the free section fault occurs, the storage device may not start reclaiming free flash blocks until the filesystem informs the storage device about the invalidated blocks. To prevent the free section fault, the filesystem needs to inform the storage device about the invalid filesystem blocks as early as possible.

The present disclosure may free a log-structured filesystem from its own garbage collection by combining a small degree of virtual overprovisioning with coupled garbage collection.

### (2) Garbage Collection Region

In D2FS, not only the filesystem but also the storage device may allocate an LBA from the filesystem partition. The present disclosure devises a mechanism to prohibit the storage device from conflicting with the filesystem in allocating an LBA. To this end, a separate region is present within the filesystem partition in which only the storage device exclusively allocates an LBA. This region is called a garbage collection region. This is named the garbage collection region since this region is used by coupled garbage collection to allocate an LBA for a destination flash block. The filesystem may read, update, or discard file blocks in the garbage collection region, but may not allocate a new LBA in the garbage collection region. When the file block in the garbage collection region is updated, the updated content is recorded in an LBA newly allocated from a regular region. FIG. 6 illustrates updating a file block within the garbage collection region. If a file block in LBA L₀ of the garbage collection region is updated, the updated content is written to LBA L′₀ of the regular region. The LBA of the file block changes from L₀ to L′₀. The filesystem discards L₀ such that the coupled garbage collection may recycle it later.

### (3) Filesystem Implementation

Coupled garbage collection, migration upcall, and virtual overprovisioning may be used in any log-structured filesystem. Currently, D2FS is implemented on F2FS. There are a few implementation-specific issues that deserve attention.

### (i) Filesystem Organization

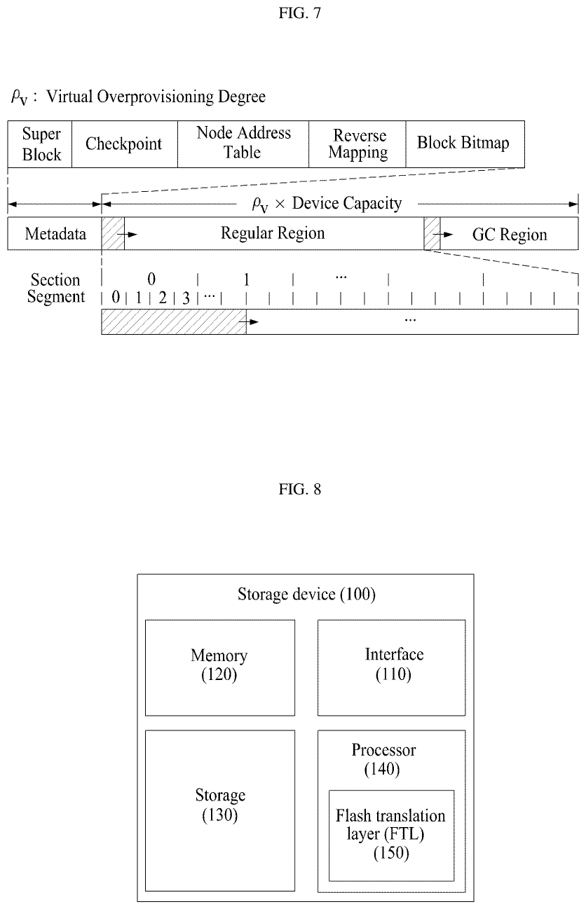

The D2FS partition includes two regions, that is, the regular region and the garbage collection region. FIG. 7 illustrates the filesystem organization. The regular region is divided into two areas, that is, a metadata area for storing metadata, and a main area for logging file blocks. D2FS has the same metadata structure as F2FS. The size of the entire filesystem partition corresponds to ρᵥ×(storage device capacity). The number of blocks in the garbage collection region may not exceed the storage device capacity. The present disclosure sets the size of the garbage collection region to be equal to the storage device capacity. The size of the regular region corresponds to (ρᵥ−1)×(storage device capacity).

### (ii) Immediate Discard

Existing filesystems (e.g., F2FS, BTRFS) transmit discard commands in a batched manner. This is to prohibit the discard commands from interfering with latency-sensitive I/O commands (e.g., read, flush) from the host. For example, F2FS dispatches the discard command only when the I/O is in an idle state. Unlike the existing approaches, D2FS dispatches the discard command immediately after filesystem blocks are invalidated. This is to invalidate a flash page that contains the invalid filesystem blocks as early as possible. The present disclosure carefully suspects that an immediate discard policy is not infeasible since the overhead of processing the discard command becomes much lighter in recent SSD products than before.

(iii) Bock Type in I/O Command

D2FS defines two block types for blocks in its filesystem partition, that is, a data block and a filemap block. In transmitting a write command to the storage device, D2FS specifies a block type using a stream interface. Coupled garbage collection clusters flash pages of the same block type in the same flash block.

### 6. Crash Recovery

The system may crash when the filesystem is in the middle of processing migration upcall. In this case, a partial subset of migration records for the migration upcall may have been made durable. D2FS ensures the failure-atomicity of servicing migration upcall using redo semantics. In a filesystem recovery process, D2FS recovers the outstanding migration records for the migration upcall and replays them.

There are three key factors to make the migration upcall failure-atomic. First, outstanding migration records (i.e., migration records with buffered or in-flight state) are protected under the unexpected power failure. Commodity SSD products adopt various techniques to protect the state of the storage device against the unexpected power failure, for example, using supercap or a spare area of a flash page. The present disclosure assumes that the outstanding migration records in a device memory are protected by these techniques. Second, D2FS guarantees the failure-atomicity for processing a single migration record. The filesystem disables the checkpoint when processing a migration record. By disabling the checkpoint during this period, the filesystem ensures that while processing a migration record, the transient state of the filesystem is not made durable and is not externally visible. Third is re-submission of the outstanding migration records. In crash recovery, the recovery routine of the filesystem examines a checkpoint pack to identify the most recently serviced migration record and instructs the storage device to re-submit the outstanding migration records (i.e., migration records that are in in-flight state). When the host receives the migration records from the storage device, the host verifies that the corresponding migration record is not serviced. By processing the remaining outstanding migration records for the migration upcall, the recovery routine redoes the migration upcall.

The contributions of the present disclosure are as follows. First, a host CPU directly eliminates the overhead of performing garbage collection. It is achieved by combining the existing I/O stack features, for example, device-level garbage collection, filesystem overprovisioning, and NVMe interface. Second, by employing a moderate degree of virtual overprovisioning (e.g., 2.4), it is discovered that free sections may be seamlessly supplied to the filesystem only with the device-level garbage collection. That is, excessive partition expansion is not required even without filesystem-level garbage collection. Third, it is proved that the storage device may deliver file mapping information to the host without relying on host-centric event detection (e.g., polling and interrupt) by piggybacking an update notification to the other I/O completion signal.

In this way, D2FS in which the filesystem-level garbage collection is eliminated outperforms F2FS by 3×, F2FS ported on ZNS SSD by 1.7 time, IPLFS by 1.5× (based on YCSB-F). Also, D2FS reduces a device memory pressure by 1/14 compared to IPLFS.

Various embodiments of the present disclosure are described based on the aforementioned description.

FIG. 8 is a diagram illustrating components of a storage device 100 according to various example embodiments.

Referring to FIG. 8, the storage device 100 may include an interface 110, a memory 120, a storage 130, and a processor 140. In some example embodiments, at least one component among the components of the storage device 100 may be omitted, and at least one another component may be added. In some example embodiments, at least two components among the components of the storage device 100 may be implemented as an integrated circuit.

The interface 110 may be provided for interfacing between the storage device 100 and a host. For example, the interface 140 may be implemented as various protocols, such as PCIe/NVMe, UFS, and eMMC.

The memory 120 may store a variety of data used by at least one component of the storage device 100. In various example embodiments, the memory 120 may store information necessary for garbage collection of the storage device 100. For example, the memory 140 may include at least one of a volatile memory and a nonvolatile memory. Data may include at least one program and input data or output data related thereto. The program may be stored in the memory 120 as software that includes at least one instruction, and may include at least one of an operating system (OS), middleware, and an application. In various example embodiments, the memory 120 may store a mapping table that includes address translation information, metadata for performing garbage collection (GC), a temporary buffer, and cache data.

The storage 130 may store user data or filesystem data in a nonvolatile manner. For example, the storage 130 may be implemented as a nonvolatile storage medium, such as a NAND flash memory, 3D XPoint, RRAM, and MRAM. The storage 130 may support page-level read and write operations and block-level erase operations. In various example embodiments, data may be stored in the storage 130 according to a write request transmitted from the host or garbage collection performed by the processor 140.

The processor 140 may control at least one component of the storage device 100 by executing a program of the memory 120. In particular, the processor 140 may control the operation of the storage 130. Through this, the processor 140 may perform data processing or operations. Here, the processor 140 may execute an instruction stored in the memory 120. In various example embodiments, the processor 140 may include a flash translation layer (FTL) 150. The flash translation layer 150 may be responsible for logical-to-physical address (L2P) mapping, garbage collection, and wear leveling. When free flash blocks become scare, the flash translation layer 150 performs device-level garbage collection. That is, the flash translation layer 150 may select a victim block, may copy valid pages in the victim block to an empty block, and then delete the victim bock to reclaim the space.

In various example embodiments, the processor 140 may set a portion of a filesystem partition as a garbage collection region used by the storage device 100 based on virtual overprovisioning (VOP). Specifically, the processor 140 may virtually expand the filesystem partition to be larger than the physical capacity of the storage device 100, and may set the same as the garbage collection region and the remaining regular region. The garbage collection region may represent a region in which the log-structured filesystem is prohibited from allocating a logical block address in the garbage collection region. Here, the garbage collection region may be set to be less than or equal to the physical capacity of the storage device 100.

In various example embodiments, the processor 140 may migrate valid pages of a victim block to a destination block based on coupled garbage collection (CGC), and may allocate a new logical block address to the valid pages in the garbage collection region. Here, the processor 140 may reclaim the victim block by discarding a previous logical block address from the victim block for the valid pages.

In various example embodiments, the processor 140 may deliver mapping information of valid pages and the logical block address to a host based on a migration upcall. Specifically, the processor 140 may notify mapping information to the host through asynchronous communication. That is, the processor 140 may notify mapping information to the host without a request from the host.

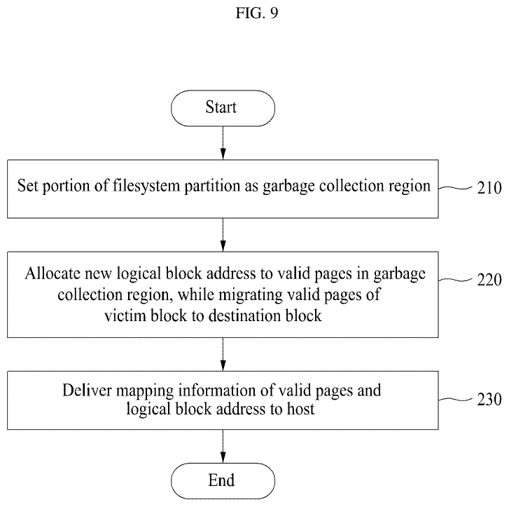

FIG. 9 is a flowchart illustrating an operating method of the storage device 100 according to various example embodiments.

Referring to FIG. 9, in operation 210, the processor 140 may set a portion of a filesystem partition as a garbage collection region used by the storage device 100 based on virtual overprovisioning (VOP). Specifically, the processor 140 may virtually expand the filesystem partition to be larger than the physical capacity of the storage device 100, and may set the same as the garbage collection region and the remaining regular region. The garbage collection region may represent a region in which the log-structured filesystem is prohibited from allocating a logical block address in the garbage collection region. Here, the garbage collection region may be set to be less than or equal to the physical capacity of the storage device 100.

In operation 220, the processor 140 may allocate a new logical block address to valid pages in the garbage collection region, while migrating the valid pages of a victim block to a destination block based on coupled garbage collection (CGC). Here, the processor 140 may reclaim the victim block by discarding a previous logical block address from the victim block for the valid pages.

In operation 230, the processor 140 may deliver mapping information of valid pages and the logical block address to a host based on a migration upcall. Specifically, the processor 140 may notify mapping information to the host through asynchronous communication. That is, the processor 140 may notify mapping information to the host without a request from the host.

The apparatuses described herein may be implemented using hardware components, software components, and/or combination of hardware components and software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to various example embodiments may be configured in a form of program instructions that may be performed through various computer devices and recorded in computer-readable media. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include ROM, PROM, EPROM, EEPROM, flash memory (e.g., NAND/NOR), SSD, HDD, magnetic tape, optical recording media (CD-ROM, DVD, BD), magneto-optical media, memory card, and USB memory. The media refer to non-transitory media, and do not include a transmission signal itself or a purely volatile memory (e.g., RAM).

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance, and the terms are simply used to distinguish one component from another component. The components should not be limited by the terms. When a component (e.g., a first component) is described to be “(functionally or communicatively) connected to” or “accessed to” another component (e.g., a second component), the component may be directly connected to the other component or may be connected through still another component (e.g., a third component).

According to various example embodiments, each (e.g., module or program) of the components may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents. Therefore, other implementations, other example embodiments, and equivalents of the claims are to be construed as being included in the claims.

What is claimed is:

1. A garbage collection method of a storage device for eliminating garbage collection overhead of a host having a log-structured filesystem, the garbage collection method comprising:
setting a portion of a filesystem partition as a garbage collection region used by the storage device; and
allocating a new logical block address to valid pages in the garbage collection region, while migrating the valid pages of a victim block to a destination block.

2. The garbage collection method of claim 1, further comprising:
delivering mapping information of the valid pages and the logical mapping address to the host.

3. The garbage collection method of claim 1, wherein the setting as the garbage collection region comprises virtually expanding the filesystem partition to be larger than the physical capacity of the storage device to set the same as the garbage collection region and a remaining regular region.

4. The garbage collection method of claim 1, wherein the garbage collection region represents a region in which the log-structured filesystem is prohibited from allocating a logical block address in the garbage collection region.

5. The garbage collection method of claim 1, wherein the garbage collection method of the storage device is performed by a flash translation layer (FTL) within the storage device.

6. The garbage collection method of claim 1, further comprising:
discarding a previous logical block address from the victim block for the valid pages after allocating the new logical block address to the valid pages.

7. The garbage collection method of claim 2, wherein the delivering of the mapping information to the host comprises notifying the mapping information to the host through asynchronous communication.

8. The garbage collection method of claim 3, wherein the garbage collection region is set to be less than or equal to the physical capacity of the storage device.

9. A storage device for eliminating garbage collection overhead of a host having a log-structured filesystem, the storage device comprising:
a memory; and
a processor configured to connect to the memory, and to execute at least one instruction stored in the memory,
wherein the processor is configured to,
set a portion of a filesystem partition as a garbage collection region used by the storage device, and
allocate a new logical block address to valid pages in the garbage collection region, while migrating the valid pages of a victim block to a destination block.

10. A non-transitory computer-readable recording medium storing a computer program to execute a garbage collection method of a storage device for eliminating garbage collection overhead of a host having a log-structured filesystem, wherein the garbage collection method comprises:
setting a portion of a filesystem partition as a garbage collection region used by the storage device; and
allocating a new logical block address to valid pages in the garbage collection region, while migrating the valid pages of a victim block to a destination block.
